(19) United States
(12) Patent Application Publication
(10) Pub. No.: US 2005/0141372 A1
(43) Pub. Date: Jun. 30, 2005

(54) Optical disk apparatus

(75) Inventor: Shigetoshi Hirai, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 10/940,958

(22) Filed: Sep. 15, 2004

(30) Foreign Application Priority Data
Dec. 26, 2003 (JP) 2003-433642

(51) Int. Cl. G11B 5/09

(52) U.S. Cl. 369/47.26; 369/47.28

(57) ABSTRACT

An optical disk apparatus includes an error arithmetic circuit which detects the relative position between the position of an LPP portion and data which is being recorded, switching units which switch a reference clock source to change the frequency of a correction clock output from a PLL unit to generate a data recording clock for a predetermined time on the basis of the direction and magnitude of a shift in the relative position between the data being recorded and the position of the LPP portion, which is detected by the error arithmetic circuit, and a control device which changes the frequency of the correction clock for a predetermined time.

### CROSS-REFERENCE TO RELATED APPLICATIONS

This application is based upon and claims the benefit of priority from prior Japanese Patent Application No. 2003-433642, filed Dec. 26, 2003, the entire contents of which are incorporated herein by reference.

### BACKGROUND OF THE INVENTION

1. Field of the Invention

The present invention relates to an information recording method and optical disk apparatus, which reduce the degree of a relative shift between recorded data and LPP recorded on an information recording medium in advance.

2. Description of the Related Art

Examples of optical disks serving as information recording media are read-only disks represented by CD-ROM and DVD-ROM, write-once-read-multiple optical disks represented by CD-R and DVD-R, and rewritable optical disks represented by CD-RW, DVD-RAM, and DVD-RW, which can be used for an external memory of a computer or a video recorder.

In a DVD-Recordable (DVD-R) or DVD-RW disk of the DVD standard, an address recording method called (Land Pre-Pit) (LPP) is used to determine the relative positional relationship between LPP and recorded data.

LPP is recorded on a disk in advance in synchronism with a wobble signal. A method of recording data by using a recording clock multiplied from the wobble signal while maintaining the phase relationship is widely used.

Jpn. Pat. Appln. KOKAI Publication No. 9-326138 discloses a method of recording information in a wobbled groove and a recording clock. This prior art proposes that, e.g., the wobble frequency fw and the pit frequency fp should have the relationship given by M×fw=N×fp (where M and N are integers) However, generating a recording clock from a wobble signal obtained by detecting wobbles formed on an optical disk in advance depends on the quality (accuracy) of wobble signal detection. For this reason, the positional relationship between a wobble signal and recorded data may be disturbed by a wobble signal detection error or the like.

In this case, since the relative position between LPP and recorded data shifts, an error occurs so that data different from data which should be played back may be played back in a data read, and the standard cannot be satisfied. Jpn. Pat. Appln. KOKAI Publication No. 9-326138 contains no description about the above-described shift in relative position between LPP and recorded data.

### BRIEF SUMMARY OF THE INVENTION

According to an aspect of the present invention, there is provided an optical disk apparatus comprising:
data position detection unit which detects a relative position between data which is being recorded and a position of an LPP portion which is formed in a recording film of an information recording medium in advance;
clock change unit which changes a frequency of a correction clock output from a PLL unit, and which generates a data recording clock, for a predetermined time on the basis of a direction and magnitude of a shift in the relative position between the data being recorded and the position of the LPP portion, which is detected by the data position detection unit; and
frequency shift time change unit which changes the frequency of the correction clock output from the PLL unit for a predetermined time in accordance with the magnitude of the shift in the relative position between the data being recorded and the position of the LPP portion, which is detected by the data position detection unit.

According to another aspect of the present invention, there is provided an information recording method comprising:
detecting a relative position between data which is being recorded and a position of an LPP portion which is formed in a recording film of an information recording medium in advance; and
changing a frequency of a correction clock output from a PLL unit, which generates a data recording clock, for a predetermined time on the basis of a direction and magnitude of a shift in the detected relative position between the data which is being recorded and the position of the LPP portion.

According to still another aspect of the present invention, there is provided an information recording method comprising:
detecting a relative position between data which is being recorded and a position of an LPP portion which is formed in a recording film of an information recording medium in advance; and
arbitrarily changing at least one of a frequency change amount and a frequency change time of a correction clock output from a PLL unit to generate a data recording clock for a predetermined time or for a predetermined unit on the basis of a direction and magnitude of a shift in the detected relative position between the data which is being recorded and the position of the LPP portion.

### BRIEF DESCRIPTION OF THE SEVERAL VIEWS OF THE DRAWING

The accompanying drawing, which is incorporated preferred in and constitutes a part of the specification, illustrates embodiments of the invention, and together with the general description given above and the detailed description of the embodiments preferred given below, serves to explain the principles of an aspect of the invention.

FIG. 1 is a schematic view for explaining an example of an optical disk apparatus to which an embodiment of the present invention is applied;

FIG. 2 is a schematic view for explaining an example of data position control using a “correction clock” in the optical disk apparatus shown in FIG. 1; and

FIG. 3 is a schematic view for explaining an example of another embodiment of the optical disk apparatus shown in FIG. 1.

### DETAILED DESCRIPTION OF THE INVENTION

An embodiment of the present invention will be described below in detail with reference to the accompanying drawing.

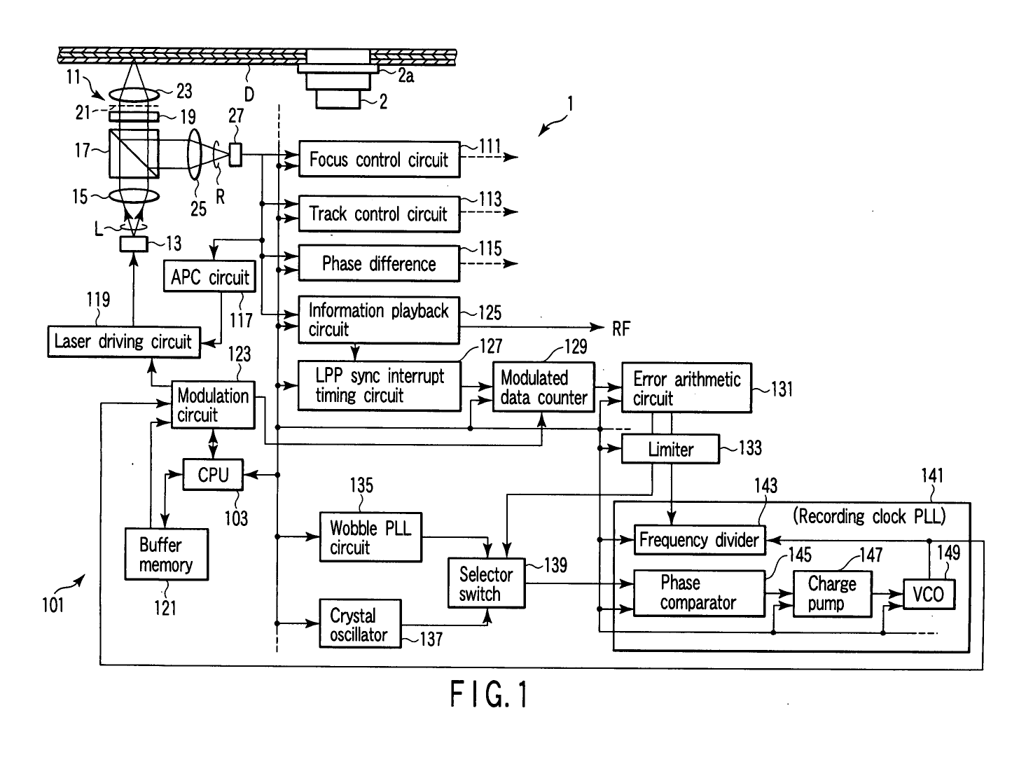

FIG. 1 is a schematic view showing an example in which the present invention is applied to an optical disk apparatus.

As shown in FIG. 1, an optical disk apparatus (information recording/playback apparatus) 1 has a disk motor 2, optical head device 11, and signal processing unit 101. The disk motor 2 is rotated at a predetermined speed by means of a motor driver (not shown). The optical head device (light source) 11 irradiates an optical disk D, which is held by a turntable 2a arranged on the shaft of the disk motor 2 and rotated at the predetermined speed, with a light beam (laser beam) to record information on or play back information from the optical disk D. The signal processing unit 101 controls information recording/playback by the optical head device 11. The signal processing unit 101 includes a CPU 103 serving as a main control device. Various control and operations to be described below are controlled by the CPU 103.

A laser beam L emitted from a semiconductor laser device 13 of the optical head device 11 is collimated through a collimator lens 15 and guided to the surface of the optical disk D through a beam splitter 17. The isolation between the laser beam L which has passed through the beam splitter 17 and a reflected laser beam R reflected by the optical disk D is adjusted by a waveplate (λ/2 plate) 19. The laser beam which has passed through the waveplate 19 is diffracted by, e.g., a right-angled prism or mirror 21 by about 90° with respect to the recording surface of the optical disk D so that the direction of the laser beam is changed toward the optical disk D, as indicated by the dotted line in FIG. 1.

The laser beam L directed to the recording surface of the optical disk D by the right-angled prism or mirror 21 is imparted with a predetermined focusing effect by an objective lens 23 and focused on the recording film of the optical disk D.

The reflected laser beam R which is reflected by the recording film of the optical disk D and whose reflectance is changed by information recorded on the recording film, or which is reflected by the recording film when information is recorded on the recording film, is returned to the objective lens 23. The direction of reflected laser beam R is changed by the right-angled prism or mirror 21 toward the waveplate 19 and beam splitter 17.

In the reflected laser beam R whose direction is changed by the right-angled prism or mirror 21 and which has passed through the waveplate 19, the direction of polarization is rotated by about 90°. For this reason, the reflected laser beam R which returns to the beam splitter 17 is separated from the recording/playback laser beam L from the semiconductor laser device 13 and guided in a predetermined direction.

An image of the reflected laser beam R which is separated from the recording/playback laser beam L from the semiconductor laser device 13 by the beam splitter 17 is formed on the light-receiving surface of a photodetector 27 through an imaging lens 25, although a detailed description thereof will be omitted. The photodetector 27 is, e.g., a known four-split detector and outputs a predetermined output which can be used for focus error and tracking error detection to be described below. In this case, the output from the photodetector 27 is converted into a voltage signal by a current-voltage (I-V) converter (not shown) and output to the subsequent stage. Recently, a photodetector incorporating a preamplifier is often used. In this case, the voltage signal is directly output. Various known methods can be used as the method of detecting a focus error and tracking error and the pattern of the light-receiving surface of the photodetector 27, as a matter of course.

The output from the photodetector 27 is input to, e.g., a focus control circuit 111 to detect a focus error amount. The output from the photodetector 27 is also converted into a focus control signal to control the position of the objective lens 23 on the basis of the focus error amount such that the distance between the objective lens 23 and the recording film of the optical disk D coincides with the focus position of the objective lens 23. The output from the photodetector 27 is also input to, e.g., a track control circuit 113 to detect a tracking error amount. The output from the photodetector 27 is also converted into a track control signal to control the position of the objective lens 23 on the basis of the tracking error amount such that the central position of the laser beam focused on the recording film of the optical disk D by the objective lens 23 coincides with the center of a groove formed in the recording film of the optical disk D in advance.

The output from the photodetector 27 is also input to, e.g., a phase difference detection circuit 115 and used for phase correction control (lens shift) to correct the track control signal of the objective lens 23 from the track control circuit 113 in correspondence with a known lens shift amount. The output from the photodetector 27 is also input to, e.g., an APC circuit 117 and used to monitor the intensity of the laser beam output from the semiconductor laser element 13.

The output from the photodetector 27 is also input to an information playback circuit 125 and supplied to a signal processing circuit (not shown) or a buffer memory (not shown) of the subsequent stage as an RF signal to play back information recorded on the optical disk, although a detailed description thereof will be omitted. The signal played back by the information playback circuit 125 also contains the wobble signal of a groove (guide groove) formed in the recording film of the optical disk D in advance and data (header information such as a sector number) recorded in land pre-pit (LPP) in advance.

The intensity of the laser beam L from the semiconductor laser device 13, which is detected by the APC circuit 117, is fed back to a laser driving circuit 119 so that the laser beam L output from the laser device 13 is controlled to an almost predetermined output level. More specifically, the intensities of recording laser beam and playback laser beam, which are modified by a modulation circuit 123, are stabilized in correspondence with, e.g., recording data stored in a recording data memory 121 serving as a buffer memory.

The output from the information playback circuit 125 is also supplied to, e.g., an LPP sync interrupt timing circuit 127 and used for interrupt. (latch) to data count which is undergoing modulation processing by a modulated data counter (data position detection means) 129.

The modulated data counter 129 receives pulses corresponding to the number of modulated data from the modulation circuit 123 and always counts the relative value from the data sync position. When this value is latched in accordance with the output from the LPP sync interrupt timing circuit 127, a value equivalent to the relative numerical value from the data sync is obtained. This value represents the relative positional shift between the data which is being recorded and the position of the LPP portion formed in the recording film of the optical disk D in advance.

For the wobble signal counted by the modulated data counter 129, the presence/absence of a shift from the ideal value, the shift amount, and the sign of the shift (the polarity representing delay/advance) are extracted by offset operation by an error arithmetic circuit 131. The error arithmetic circuit 131 determines the phase correction direction (to be referred to as a correction direction hereinafter) and the frequency shift direction of a data position correction clock (to be referred to as a correction clock hereinafter) on the basis of the arithmetic value of the shift sign.

For the “correction direction and correction clock” determined by the error arithmetic circuit 131, the “response” is optimized by a limiter 133. Then, the correction direction and correction clock are input to a selector switch 139 and a frequency divider 143 in a recording clock (phase-lock loop) (PLL) unit 141. The selector switch 139 switches between a wobble PLL circuit 135 used for a normal clock and an crystal oscillator 137 with a fixed frequency, which outputs a reference clock. The limiter 133 acts on at least one of the amplitude (the shift amount when the frequency divider 143 to be described below shifts the frequency) and time (the shift time length when the frequency divider 143 to be described below shifts the frequency) and is effectively used to prevent any problem such as runway, in the worst case, caused by an abrupt variation in clock switching.

The control signal of the “correction clock” input to the frequency divider 143 is set to “lower speed by given amount” when the wobble data advances from the ideal position of LPP. Conversely, when the data delays from the ideal position of LPP, the control signal is set to “higher speed by given amount”. In the example shown in FIG. 1, the frequency division multiple (multiplier) of the frequency divider 143 is switched.

For the “correction clock” set by the frequency divider 143, the presence/absence of a phase difference and the magnitude of the phase difference are obtained by a phase comparator 145 by using, as the reference of the recording clock, the oscillation frequency of a frequency-fixed oscillator and, for example, the crystal oscillator 137 switched by the selector switch 139.

The obtained phase difference is converted into a voltage signal by a charge pump 147 and input to a (voltage-controlled oscillator) (VCO) 149.

More specifically, when the “correction direction and correction clock” are determined by the error arithmetic circuit 131, the “correction clock” is supplied to the modulation circuit 123 and frequency divider 143 in the recording clock PLL unit 141. The time (length) of supply of the “correction clock” is limited to a predetermined time. Since the time corresponding to the “correction direction and correction clock” output from the error arithmetic circuit 131 can be adjusted by the limiter 133, overshooting can be avoided. Hence, when the recording clock is changed, the undesirable degradation in jitter level after recording can be reduced.

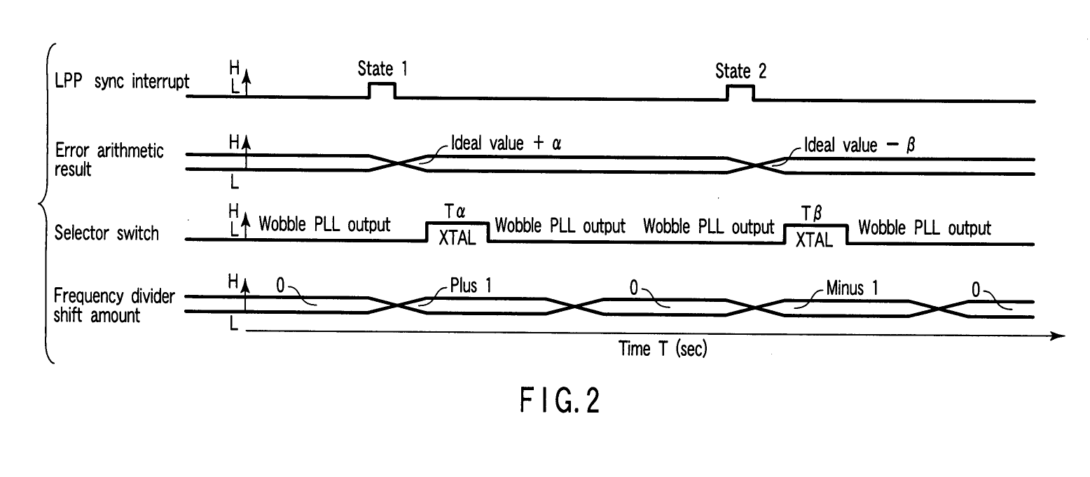

An example of the above-described control to switch between the “normal clock” and the “correction clock” will be described next with reference to FIG. 2.

Referring to FIG. 2, the abscissa is the time axis. Time elapses in the direction of the arrow. Referring to FIG. 2, the ordinate represents the “LPP sync interrupt timing”, “error operation/arithmetic result”, “switching of selector switch”, and “frequency divider shift amount”.

When the LPP sync interrupt timing circuit 127 executes an interrupt for a data count at an arbitrary position, the modulated data counter 129 latches the data count value which is undergoing modulation processing.

The latched data count value is subjected to offset operation by the error arithmetic circuit 131 so that the presence/absence of a shift from the ideal value and the magnitude and the sign of the shift are extracted.

On the basis of the extraction result, the direction in which the phase should be corrected is determined, and the frequency shift amount, i.e., “correction direction and correction clock” are set.

For example, when the data counter 129 is interrupted at the timing indicated by “state 1” in FIG. 2, the magnitude and sign of the shift are determined by the error arithmetic circuit 131. When the data advances from the ideal position (ideal value+α), a correction clock for “lower speed by given amount” is set.

On the other hand, when the data counter 129 is interrupted at the timing indicated by “state 2” in FIG. 2, and the data delays from the ideal position (ideal value−α), a correction clock for “higher speed by given amount” is set.

Hence, in each state, the selector switch 139 is switched for the predetermined time (time length T). During that time, the reference clock (XTAL) with a fixed frequency is output from the crystal oscillator 137.

The frequency divider 143 outputs a clock shifted for every minimum unit [1] during a shift time which is longer by a predetermined time than the length of the time during which the selector switch 139 is switched.

The shift amount of the correction clock to the high speed or low speed is set under the control of, e.g., the CPU 103 in accordance with conditions:
A) the PLL response time, i.e., a time “T_{PLL}” after the clock is switched to the “correction clock” until its effect is reflected is more than at least the minimum value represented by “Tα” and “Tβ” in FIG. 2, and
B) the change amount of the recording clock frequency falls within the range of 5% of a normal oscillation frequency fn.

More specifically, when the change amount of the frequency in B) is too large, the jitter of data recorded at the frequency change point degrades. When the maximum shift amount is set to 10% in consideration of such an individual difference that the playback apparatus to be used for playback is not always the same as the apparatus used for recording, the upper limit of the shift amount is about ½ of the maximum value. For A), as the frequency shift amount increases, the response time “T_{PLL}” shortens, and the jitter increases.

Hence, the time length (Tα or Tβ) in which the “correction clock” is used is preferably set to a time proportional to, e.g., the obtained shift amount (magnitude of the shift). Alternatively, for example, ranks may be defined in correspondence with shift amounts, the magnitude of the shift may be divided for certain ranges, and the time length may be set for each section.

For example, when the shift amount, which is indicated as a frequency divider shift amount in FIG. 2, is ±1 of the relative minimum error detection amount between LPP and data sync (the unit can arbitrarily be set to, e.g., a bit or a byte, or several bits or several bytes, or 1/2(about 5 bytes) of the wobble period [an arbitrary number of bits defined for the standard]), the stability near the convergence point can be increased by relatively decreasing the gain of the “correction clock” output from the recording clock PLL unit 141. As described above, using the recording clock shifted for every minimum unit during the shift time which is longer by a predetermined time than the length of the time during which the selector switch 139 is switched means that the frequency shift amount, which is indicated as the frequency divider shift amount in FIG. 2, is made as small as possible, and the change time to the correction clock is prolonged. With this operation, any decrease in jitter of the recorded data can be prevented.

As the timing of detecting the above-described shift detection (detecting the presence/absence of a shift) (under, e.g., the CPU 103),
a) shift detection is executed immediately before the start of recording, and immediately after that, the clock is switched to the correction clock for a predetermined time, or
b) shift detection is executed at an arbitrary timing during the recording period, and the correction operation can be performed (the clock is switched to the correction clock for a predetermined time) any time.

When the above-described two kinds of correction timings are used, an effect unique to each timing can be obtained. For example, when the shift is detected at the timing a), the shift can be detected in playback immediately before recording. Hence, LPP detection is stable, and a reliable operation can be expected. On the other hand, according to the timing b), since the relative position between the clock and the data recording position can be corrected in real time, the correction accuracy can be increased.

In the example shown in FIG. 1, the crystal oscillator 137 is used as the reference of the correction clock. As the reference clock, the output from the wobble PLL circuit may be used directly, and only the multiplication ratio of the frequency divider 143 may be switched.

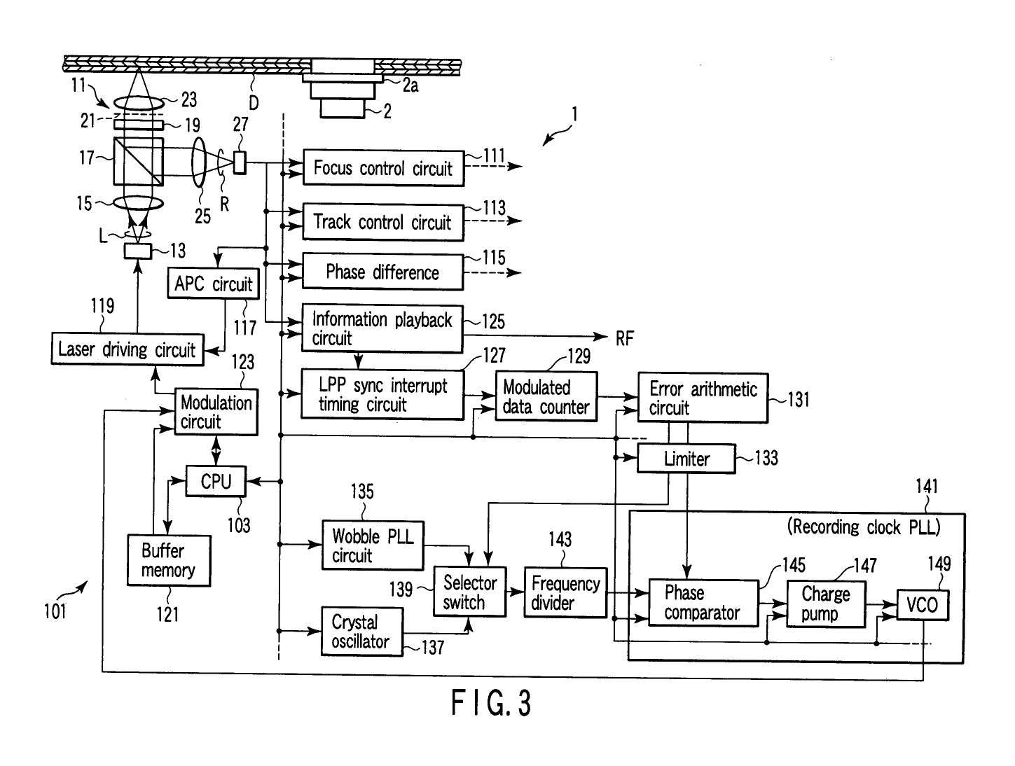

For example, as shown in FIG. 3, the frequency divider 143 may be arranged at the preceding stage of the selector switch 139 and recording clock PLL unit 141, i.e., between the phase comparator 145 and the selector switch 139. In this case, the polarity of the correction clock is reversed.

As described above, according to the present invention, the relative position between LPP and recording data can be corrected at an arbitrary recording position.

In addition, according to the present invention, in correcting the relative position between LPP and recording data at an arbitrary recording position, overshoot can be avoided, and the stability near the convergence point can be increased.

Furthermore, according to the present invention, in correcting the relative position between LPP and recording data by changing the recording clock, any degradation in jitter of the recorded data can be prevented.

Hence, according to the present invention, an information recording and optical disk apparatus can be achieved, which can reduce the degree of relative shift between recorded data and LPP recorded on an information recording medium in advance when information is to be recorded on the information recording medium on which information can be recorded.

The present invention is not limited to the above-described embodiments, and in practicing the present invention, various changes and modifications can be made without departing from the spirit and scope of the invention. The embodiments may appropriately be combined as much as possible. In this case, an effect by the combination can be obtained. The arrangement shown in FIG. 1 or 3 can also be implemented by software.

1. An optical disk apparatus comprising:
data position detection unit which detects a relative position between data which is being recorded and a position of an LPP portion which is formed in a recording film of an information recording medium in advance;
clock change unit which changes a frequency of a correction clock output from a PLL unit, and which generates a data recording clock, for a predetermined time on the basis of a direction and magnitude of a shift in the relative position between the data being recorded and the position of the LPP portion, which is detected by the data position detection unit; and
frequency shift time change unit which changes the frequency of the correction clock output from the PLL unit for a predetermined time in accordance with the magnitude of the shift in the relative position between the data being recorded and the position of the LPP portion, which is detected by the data position detection unit.

2. An apparatus according to claim 1, wherein when a relative minimum error detection amount detected by the data position detection unit is ±1, at least one of the frequency change amount and the frequency change time of the correction clock output from the clock change unit is relatively decreased.

3. An apparatus according to claim 1, further comprising limiter unit, arranged at a preceding stage of the clock change unit, which optimizes the time when the direction and magnitude of the shift in the relative position between the data which is being recorded and the position of the LPP portion, which is detected by the data position detection unit, are input to the clock change unit.

4. An apparatus according to claim 3, wherein the time during which the frequency of the correction clock is changed by the clock change unit is set longer than a predetermined time during which jitter of the data which is being recorded is not abruptly changed.

5. An apparatus according to claim 3, wherein the amount of change of the frequency of the correction clock by the clock change unit is set to an amplitude at which jitter of the data which is being recorded is not abruptly changed.

6. An apparatus according to claim 4, wherein the amount of change of the frequency of the correction clock by the clock change unit is stepwise set to an amount which does not abruptly change the jitter of the data which is being recorded.

7. An information recording method comprising:
detecting a relative position between data which is being recorded and a position of an LPP portion which is formed in a recording film of an information recording medium in advance; and
changing a frequency of a correction clock output from a PLL unit, which generates a data recording clock, for a predetermined time on the basis of a direction and magnitude of a shift in the detected relative position between the data which is being recorded and the position of the LPP portion.

8. A method according to claim 7, wherein when a relative minimum error detection amount of the detected relative position is ±1, at least one of the frequency change amount and the frequency change time of the correction clock is relatively decreased.

9. A method according to claim 7, wherein the timing at which the frequency of the correction clock is changed is optimized by using the direction and magnitude of the shift in the detected relative position between the data which is being recorded and the position of the LPP portion.

10. A method according to claim 7, wherein the time during which the frequency of the correction clock is changed is set longer than a predetermined time during which jitter of the data which is being recorded is not abruptly changed.

11. A method according to claim 7, wherein the change amount of the frequency of the correction clock is set to an amount which does not abruptly change jitter of the data which is being recorded.

12. A method according to claim 7, wherein at least one of the frequency change amount and the frequency change time of the correction clock is stepwise set to an amount which does not abruptly change jitter of the data which is being recorded.

13. An information recording method comprising:
detecting a relative position between data which is being recorded and a position of an LPP portion which is formed in a recording film of an information recording medium in advance; and
arbitrarily changing at least one of a frequency change amount and a frequency change time of a correction clock output from a PLL unit to generate a data recording clock for a predetermined time or for a predetermined unit on the basis of a direction and magnitude of a shift in the detected relative position between the data which is being recorded and the position of the LPP portion.

14. A method according to claim 13, wherein when a relative minimum error detection amount of the detected relative position is ±1, at least one of the frequency change amount and the frequency change time of the correction clock is relatively decreased.

15. A method according to claim 13, wherein the timing at which the frequency of the correction clock is changed is optimized by using the direction and magnitude of the shift in the detected relative position between the data which is being recorded and the position of the LPP portion.

16. A method according to claim 13, wherein the time during which the frequency of the correction clock is changed is set longer than a predetermined time during which jitter of the data which is being recorded is not abruptly changed.

17. A method according to claim 13, wherein the change amount of the frequency of the correction clock is set to an amount which does not abruptly change jitter of the data which is being recorded.

18. A method according to claim 13, wherein at least one of the frequency change amount and the frequency change time of the correction clock is stepwise set to an amount which does not abruptly change jitter of the data which is being recorded.
